(19) United States
(12) Patent Application Publication
(10) Pub. No.: US 2006/0293397 A1
(43) Pub. Date: Dec. 28, 2006

(54) Surfactants derived from phenolic aldehydes

(76) Inventors: Kevin Rodney Lassila, Westford, MA (US); Michael Ulman, Alburtis, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/159,535

(22) Filed: Jun. 23, 2005

(51) Int. Cl. B01F 17/00; B01F 3/08

(52) U.S. Cl. 516/204

(57) ABSTRACT

Surfactants derived from phenolic aldehydes include compounds according to formulas (I) and (II) 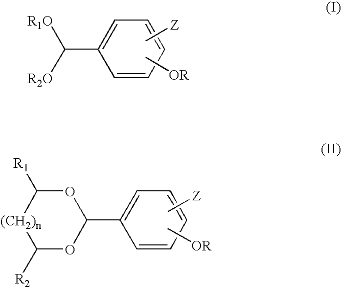
wherein R is (CH₂CH₂O)ₓR₄ or (C₃H₆O₂)ₓR₄. R₁ and R₂ are each hydrogen or C1-C20 hydrocarbyl moieties, provided that neither R₁ nor R₂ may be hydrogen when the compound is of formula (I). If the compound is according to formula (II) wherein n=0, one of R₁ and R₂ may further be C1-C20 alkoxymethylene while the other is H. The Z moiety is hydrogen, OR, or OR₃, wherein R₃ is hydrogen, methyl, ethyl or propyl; R₄ is hydrogen, methyl or ethyl; x is an integer from 1 to 20; and n is 0 or 1. Compositions containing the surfactants, and methods of using the surfactants, are also disclosed.

### BACKGROUND OF THE INVENTION

This invention relates to surfactant compositions. More particularly, it relates to surfactants derived from phenolic aldehydes.

The ability to reduce the surface tension of water is of great importance in the application of water-based formulations because decreased surface tension translates to enhanced substrate wetting during use. Examples of water-based compositions requiring good wetting include coatings, inks, adhesives, fountain solutions for lithographic printing, cleaning compositions, metalworking fluids, agricultural formulations, electronics cleaning and semiconductor processing compositions, personal care products, and formulations for textile processing and oilfield applications. Surface tension reduction in water-based systems is generally achieved through the addition of surfactants, resulting in enhanced surface coverage, fewer defects, and more uniform distribution. Equilibrium surface tension (EST) is important when the system is at rest, while dynamic surface tension (DST) provides a measure of the ability of a surfactant to reduce surface tension and provide wetting under high speed application conditions.

The importance of the ability of a surfactant to achieve low surface tension at low use levels, the ability to affect foaming performance, and the surfactant's ability to provide efficient emulsification and solubilization are all of considerable industrial importance, as is well-appreciated in the art. And, although equilibrium surface tension reduction efficiency is important for some applications, other applications may require both equilibrium and dynamic surface tension reduction.

The foaming characteristics of a surfactant are also important because they can help define applications for which the surfactant might be suitable. For example, foam can be desirable for applications such as ore flotation and cleaning. On the other hand, in coatings, graphic arts and adhesive applications, foam is undesirable because it can complicate application and lead to defect formation. Thus foaming characteristics are frequently an important performance parameter.

The wide variety of applications for which surfactants are used, and the resultant variation in performance requirements, results in a need for a correspondingly large number of surfactants adapted to these various performance demands, and a need for suitable methods for making them.

### BRIEF SUMMARY OF THE INVENTION

In one aspect, the invention provides a composition comprising one or more compounds according to formula (I) or formula (II) 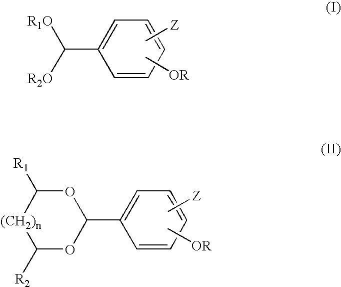
wherein R is (CH₂CH₂O)ₓR₄ or (C₃H₆O₂)ₓR₄; R₁ and R₂ are each independently selected from the group consisting of hydrogen and C1-C20 linear, cyclic, and branched alkyl, alkenyl, aryl, aralkyl, and alkaryl moieties, and wherein if the compound is according to formula (II) wherein n=0, one of R₁ and R₂ may further be C1-C20 alkoxymethylene and the other is H; Z is hydrogen, OR, or OR₃, wherein R₃ is selected from the group consisting of hydrogen, methyl, ethyl and propyl; R₄ is selected from the group consisting of hydrogen, methyl and ethyl; x is an integer from 1 to 20; and n is 0 or 1; provided that neither R₁ nor R₂ may be hydrogen when the compound is of formula (I).

In another aspect, the invention provides a method for reducing surface tension in a formulation. The method includes adding to the formulation an effective amount of one or more compounds according to formula (I) or formula (II) as shown above, sufficient to reduce an equilibrium surface tension of the formulation to a value less than 52 mN/m.

In yet another aspect, the invention provides aqueous compositions, or formulations, for various applications containing an effective amount of one or more compounds according to formula (I) or formula (II) as shown above, sufficient to reduce an equilibrium surface tension of the aqueous composition to a value less than 52 mN/m. Such compositions comprising one or more of these compounds include coatings, inks, adhesives, agricultural formulations, fountain solutions, photoresist strippers and developers, shampoos, bodywashes, detergents, and other cleaning compositions. The compounds may also find use compositions in oil-field exploration, development, and production applications such as enhanced oil recovery, fracturing and stimulation processes, and drilling and cementing operations.

### BRIEF DESCRIPTION OF SEVERAL VIEWS OF THE DRAWINGS

FIG. 1 shows dynamic surface tension data for surfactants containing octanediol acetals of ethoxylated vanillin, according to the invention.

FIG. 2 shows dynamic surface tension data for surfactants containing decanediol acetals of ethoxylated vanillin, according to the invention.

FIG. 3 shows a comparison of biodegradation data for surfactants according to the invention, relative to a positive control.

### DETAILED DESCRIPTION OF THE INVENTION

The present invention relates to novel surfactant compositions that are capable of effectively reducing the dynamic and/or equilibrium surface tension of aqueous systems, and/or affecting foaming performance of such systems. The compositions include one or more compounds according to formula (I) or formula (II) 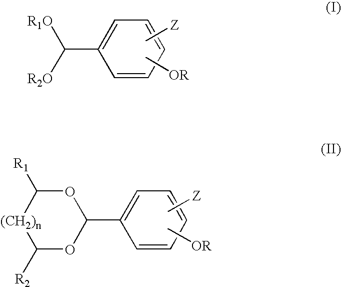
wherein R is (CH₂CH₂O)ₓR₄ or (C₃H₆O₂)ₓR₄, x is an integer from 1 to 20, and n is 0 or 1. The repeating group in (C₃H₆O₂)ₓR₄ represents a polyglycerol moiety, which may be (CH₂CH(CH₂OH)O)ₓR₄ and/or (CH₂CH(OH)CH₂O)ₓR₄ in any sequence, and which also may be branched. The substituents R₁ and R₂ are each independently selected from the group consisting of hydrogen and C1-C20 linear, cyclic, and branched alkyl, alkenyl, aryl, aralkyl, and alkaryl moieties, provided that neither R₁ nor R₂ may be hydrogen when the compound is of formula (I). In some embodiments, at least one of R₁ and R₂ is C1-C10 linear alkyl, typically 1-hexyl or 1-octyl. Other nonlimiting examples of suitable R₁ and R₂ groups include butyl, 2-ethylhexyl, decyl, dodecyl, tetradecyl, hexadecyl, octadecyl, phenyl, and mixtures thereof. Typically, the R₁ and R₂ groups will be one or more of butyl, 2-ethylhexyl, octyl, decyl, dodecyl, and tetradecyl. R₁ and R₂ in formula 1 compounds may be the same or different. In compounds of formula (II) in which n=0, one of R₁ and R₂ may also be C1-C20 alkoxymethylene, with the other being hydrogen; i.e., the compound of formula (II) may be an acetal formed from the primary and secondary OH groups of an alkyl glyceryl ether. One nonlimiting example of a suitable alkyl glyceryl ether is 2-ethylhexyl glyceryl ether; i.e., one of R₁ and R₂ is 2-ethylhexyloxymethylene. The Z group may be hydrogen, OR, or OR₃, wherein the R₃ group may be hydrogen, methyl, ethyl or propyl, particularly methyl or ethyl. R₄ may be hydrogen, methyl or ethyl. In some exemplary embodiments, Z is OR₃ and is at a meta position and OR is at the para position, relative to the acetal group of formula (I) or (II), for example when the compound is derived from vanillin. If Z is hydrogen, the compound of formula (I) or (II) may be derived from 3- or 4-hydroxybenzaldehyde. Typical values of x are at least 3.

Specific examples of compounds according to the invention include, but are not limited to, ethoxylates of any of the following acetals: 1,2-octanediol vanillin acetal, 1,2-decanediol vanillin acetal, glyceryl 2-ethylhexyl ether vanillin acetal, glyceryl dodecyl ether vanillin acetal, glyceryl decyl ether vanillin acetal, glyceryl octyl ether vanillin acetal, glyceryl hexyl ether vanillin acetal, 1,2-octanediol dihydroxybenzaldehyde acetal, 1,2-decanediol dihydroxybenzaldehyde acetal, glyceryl 2-ethylhexyl ether dihydroxybenzaldehyde acetal, glyceryl dodecyl ether dihydroxybenzaldehyde acetal, glyceryl decyl ether dihydroxybenzaldehyde acetal, glyceryl octyl ether dihydroxybenzaldehyde acetal, glyceryl hexyl ether dihydroxybenzaldehyde acetal, 1,2-octanediol ethylvanillin acetal, 1,2-decanediol ethylvanillin acetal, glyceryl 2-ethylhexyl ether ethylvanillin acetal, glyceryl dodecyl ether ethylvanillin acetal, glyceryl decyl ether ethylvanillin acetal, glyceryl octyl ether ethylvanillin acetal, glyceryl hexyl ether ethylvanillin acetal, bis-butanol vanillin acetal, bis-pentanol vanillin acetal, bis-hexanol vanillin acetal, bis-heptanol vanillin acetal, bis-octanol vanillin acetal, bis-decanol vanillin acetal, bis-dodecanol vanillin acetal, bis-tetradecanol vanillin acetal, and bis-2-ethylhexanol vanillin acetal.

Also suitable are polyglycerol ethers of any of the following acetals: 12-octanediol vanillin acetal, 1,2-decanediol vanillin acetal, glyceryl 2-ethylhexyl ether vanillin acetal, glyceryl dodecyl ether vanillin acetal, glyceryl decyl ether vanillin acetal, glyceryl octyl ether vanillin acetal, glyceryl hexyl ether vanillin acetal, 1,2-octanediol dihydroxybenzaldehyde acetal, 1,2-decanediol dihydroxybenzaldehyde acetal, glyceryl 2-ethylhexyl ether dihydroxybenzaldehyde acetal, glyceryl dodecyl ether dihydroxybenzaldehyde acetal, glyceryl decyl ether dihydroxybenzaldehyde acetal, glyceryl octyl ether dihydroxybenzaldehyde acetal, glyceryl hexyl ether dihydroxybenzaldehyde acetal, 1,2-octanediol ethylvanillin acetal, 1,2-decanediol ethylvanillin acetal, glyceryl 2-ethylhexyl ether ethylvanillin acetal, glyceryl dodecyl ether ethylvanillin acetal, glyceryl decyl ether ethylvanillin acetal, glyceryl octyl ether ethylvanillin acetal, glyceryl hexyl ether ethylvanillin acetal, bis-butanol vanillin acetal, bis-pentanol vanillin acetal, bis-hexanol vanillin acetal, bis-heptanol vanillin acetal, bis-octanol vanillin acetal, bis-decanol vanillin acetal, bis-dodecanol vanillin acetal, bis-tetradecanol vanillin acetal, and bis-2-ethylhexanol vanillin acetal.

Preparation of Compounds of Formulas (I) and (II)

Compounds according to formula (I) or (II) may be prepared by any method known in the synthetic organic chemical art. In one exemplary embodiment of the invention, they may be prepared by reaction of a hydroxybenzaldehyde with an alcohol or a vicinal diol under acid catalysis and with removal of water to convert the aldehyde to an acetal. Removal of water may be aided by any means known in the art, for example by azeotropic distillation or by scavenging by an absorbent, such as molecular sieves or anhydrous salts, or by use of a water-reactive reagent such as 2,2-dimethoxy propane or trialkyl orthoformate, among others. One suitable hydroxybenzaldehyde is vanillin, which may be obtained from any of a variety of natural or synthetic sources such as from vanilla beans, lignin, bacterial synthesis, or other sources.

Alternatively, the acetal can be made by reaction of a hydroxybenzaldehyde with an epoxide in the presence of methyl rhenium trioxide, palladium, platinum, titanium or other catalysts. Methods of performing such reactions are well known in the art, and are described for example in Organometallics 1997, 16, 3658 and in J. Mol. Cat. A:Chem 1999, 142(3), 305.

The resulting phenolic acetal may be linked to an existing polyglycerol or poly(ethylene glycol) chain, for example using the general procedure described in Fette, Seifen, Anstrichmittel (1969), 71(12), 1005-6. As another option, the phenolic acetal may be treated with ethylene oxide or glycidol under base or acid catalysis to grow a hydrophilic polyethoxylate or polyglycerol group, respectively, off of the phenolic hydroxyl. The properties of the resulting surfactant can be tuned by varying the length of the hydrophobic alcohol chain and the hydrophilic ethylene oxide or polyglycerol chain.

Uses of Compounds of Formulas (I) and (II)

Compositions according to the invention may also include a variety of other ingredients adapted to complement the utility of compounds of formulas (I) and (II) in a number of applications. The performance properties of such products may be optimized for a specific application by appropriate selection of the basic structure of the surfactant from formula (I) or (II), and by suitable choices of substituents. Such optimization is routine, and within the ability of the person of ordinary skill in the art in the particular application area. Thus manipulation of these variables yields compounds which may be useful as emulsifiers or detergents, wetting agents, foaming agents, defoamers, rheology modifiers or associative thickeners, dispersants, and the like. As such, these compounds may be useful in applications such as coatings, inks, adhesives, agricultural formulations, fountain solutions, photoresist strippers and developers, shampoos, bodywashes, detergents, and other cleaning compositions. The compounds may also find use in oil-field exploration, development, and production applications such as enhanced oil recovery, fracturing and stimulation processes, and drilling and cementing operations, and may also be useful in various wet-processing textile operations, such as dyeing of fibers and fiber scouring and kier boiling. The general formulation principles governing each of these applications are well known in the respective arts, and a detailed description of the numerous application areas and methods for incorporating the compounds of this invention into such formulations is not necessary to their effective incorporation therein. However, as an indication of the wide scope of possible uses for compounds according to the invention, exemplary but nonlimiting formulations are set forth below for a number of application areas.

The terms “water-based”, “waterborne”, “aqueous”, or “aqueous medium”, or “aqueous carrier” as used herein refer to systems in which the solvent or liquid dispersing medium comprises at least 50 wt % water, preferably at least 90 wt %, and more preferably at least 95 wt % water. The dispersing medium may consist essentially of water, i.e., it may have no added solvents.

In broad terms, compounds according to formulas (I) and (II) may be used in a wide range of formulations that include a second component, such that the application of the second component benefits from the surface active properties provided by the formula (I) or (II) material. It is to be understood that, although components of a pre- or post-preparation synthesis reaction mixture for preparation of the compounds according to formula (I) or (II) may be present, these do not count as part of the second component for purposes of this invention. Such components might for example include simple salts, solvents, catalysts, organic precursors, reagents, side products, and byproducts related to the preparation of the compound of formula (I) or (II), and these are not part of the second component. Typically, but not necessarily, the amount by weight of the second component in a formulation will be greater than that of the compound(s) of formula (I) or (II).

Formulations containing compounds according to formula (I) or (II) according to the invention are typically constructed so as to be fluid at 25° C. They are typically aqueous, but they need not be. The second component may consist of one or more materials selected from the group consisting of mineral acids, formic acid, acetic acid, tetramethylammonium hydroxide, nonvolatile organic materials, nonvolatile inorganic materials, and mixtures of these. As used herein, the term “nonvolatile” means that the indicated material either cannot boil, or it boils at a temperature of at least 150° C. at a pressure of 760 Torr. Thus, although typical volatile solvents may be included in the formulation, they do not constitute a part of the second component. Such volatile solvents, or water, or a combination of these, may in some embodiments be part of a third component of the formulation. Typically, the second and third components in combination constitute between 0.1 and 99.9 wt % of the formulation.

Typical non-limiting examples of nonvolatile materials are given in the exemplary formulations provided hereinafter. Formulations according to the invention may include ready-to-use formulations, or concentrates. Either of these may be further diluted in use. Thus the concentration of the one or more compounds of formula (I) or (II) in a composition according to the invention may vary over a wide range. Typically it will be between 0.001 and 45 wt % of the formulation, although in some cases the amount may be as low as 0.00001 wt %. In many cases compositions at the higher end of this concentration range will be diluted during or before use in the intended application, although this is not required in all applications.

By using compounds of formula (I) or (II), it is possible to reduce surface tension in a waterborne composition or an industrial process. Thus the invention provides aqueous compositions comprising such compounds, wherein the surfactant provides good wetting properties when used in a surfactant effective amount. For example, the amount of surfactant that is effective to provide enhanced wetting properties of a water-based, organic compound containing composition may range from 0.00001 to 5 wt %, preferably from 0.0001 to 3 wt %, and most preferably from 0.001 to 3 wt %, based on total weight of the formulation. Typically, when used in an aqueous formulation, the surfactant will be used in an amount that reduces the equilibrium surface tension to less than about 52 mN/m, and the amount required to do this is generally at most 5 wt % and more commonly at most 1%. However, other amounts may be used to achieve other surface tension values. The most favorable amount will vary from one application to another, depending upon the amount and type of other species present in the formulation that are capable of affecting foam properties and wetting performance, for example latex polymers.

A typical water-based coating formulation that includes the surfactants of the invention may include the following components in an aqueous medium, typically at 30 to 80% solids:

Typical Aqueous-Based Coating Formulation

| | |
|---|---|
| 0 to 50 wt % | Pigment Dispersant/Grind Resin |
| 0 to 80 wt % | Coloring Pigments/Extender Pigments/Anti- |
| | Corrosive Pigments/Other Pigment Types |
| 5 to 99.9 wt % | Water-Borne/Water-Dispersible/Water-Soluble |
| | Resins |
| 0 to 30 wt % | Slip Additives/Antimicrobials/Processing |
| | Aids/Defoamers |
| 0 to 50 wt % | Coalescing or Other Solvents |
| 0.01 to 10 wt % | Surfactant/Wetting/Flow and Leveling Agents, |
| | other than Compound of Formula (I) or (II) |
| 0.001 to 5 wt % | Compound(s) of Formula (I) or (II) |

A typical water-based ink composition that includes the surfactants of the invention may include the following components in an aqueous medium at a 20 to 60% solids content (i.e., not including the coalescing solvent):

Typical Aqueous-Based Ink Composition

| | |
|---|---|
| 1-50 wt % | Pigment |
| 0 to 50 wt % | Pigment Dispersant/Grind Resin |
| 0 to 50 wt % | Clay base in appropriate resin solution vehicle |
| 5 to 99.9 wt % | Water-borne/water-dispersible/water-soluble resins |
| 0 to 30 wt % | Coalescing Solvents |
| 0.01 to 10 wt % | Surfactant/Wetting Agents, other than |
| | Compound(s) of Formula (I) or (II) |
| 0.01 to 10 wt % | Processing Aids/Defoamers/Solubilizing Agents |
| 0.001 to 5 wt % | Compound(s) of Formula (I) or (II) |

A typical water-based agricultural composition that includes the surfactants of the invention may include the following components in an aqueous medium at 0.01 to 80% of the following ingredients:

Typical Aqueous-based Agricultural Composition

| | |
|---|---|
| 0.1-50 wt % | Pesticide or Plant Growth Modifying Agent |
| 0.01 to 10 wt % | Surfactants, other than Compound(s) of Formula (I) |
| | or (II) |
| 0 to 5 wt % | Dyes |
| 0 to 20 wt % | Thickeners/Stabilizers/Co-surfactants/Gel |
| | Inhibitors/Defoamers |
| 0 to 25 wt % | Antifreeze agent (e.g. ethylene glycol or propylene |
| | glycol) |
| 0.001 to 5 wt % | Compound(s) of Formula (I) or (II) |

A typical fountain solution composition for planographic printing that includes the surfactants of the invention may include the following components:

Typical Fountain Solution for Planographic Printing

| | |
|---|---|
| 0.05 to 10 wt % | Film forming, water soluble macromolecule |
| 1 to 25 wt % | C2-C12 Alcohol, glycol, or polyol (water soluble, |
| | or soluble due to use of a co-solvent) |
| 0.01 to 20 wt % | Water soluble organic acid, inorganic acid, or a |
| | salt of these |
| 30 to 98.9 wt % | Water |
| 0.001 to 5 wt % | Compound(s) of Formula (I) or (II) |

A typical hard surface cleaner that includes the surfactants of the invention may include the following components:

Typical Hard Surface Cleaner

| | |
|---|---|
| 0 to 25 wt % * | Anionic surfactant |
| 0 to 25 wt % * | Cationic surfactant |
| 0 to 25 wt % * | Nonionic surfactant (e.g. alcohol alkoxylates, |
| | etc.) |
| 0 to 20 wt % | Chelating agent (EDTA, citrate, tartrate, etc.) |
| 0 to 20 wt % * | Solvent (Glycol ether, lower alcohols, etc.) |
| 0.001 to 25 wt % | Compound(s) of Formula (I) or (II) |
| 0 to 2 wt % | Dye, fragrance, preservative, etc. |
| 0 to 40 wt % * | Alkali metal hydroxide |
| Balance to 100 wt % | Water, and optionally other ingredients |

* To total, in combination, between 0.1 and 99 wt %.

A typical water-based photoresist developer or electronic cleaning composition that includes the surfactants of the invention may include the following components:

Typical Aqueous-Based Photoresist Developer Composition

| | |
|---|---|
| 0.1 to 3 wt % | Tetramethylammonium hydroxide |
| 0 to 4 wt % | Phenolic resin |
| 92.5 to 99.9 wt % | Water |
| 0.001 to 5 wt % | Compound(s) of Formula (I) or (II) |

A typical metalworking fluid that includes the surfactants of the invention may include the following components:

Typical Synthetic Metalworking Fluid Formulation

| | |
|---|---|
| 2.5 to 10 wt % | Block copolymer or other emulsifying agent |
| 10 to 25 wt % | Alkanolamine |
| 2 to 10 wt % | Organic monoacid |
| 0 to 5 wt % | Organic diacid |
| 40 to 84.4 wt % | Water |
| 1 to 5 wt % | Biocide |
| 0.001 to 5 wt % | Compound(s) of Formula (I) or (II) |

Surfactants are also used in a wide variety of products in the areas of personal care and household and industrial cleaning. The surfactants of the present invention may be used in any of these formulations to provide one or more benefits, with the exact structure of the surfactant compound depending upon the specific performance features required for a particular application. Typical formulations used in these markets are described in Louis Ho Tan Tai's book, Formulating Detergents and Personal Care Products: A Complete Guide to Product Development (Champaign, Ill.: AOCS Press, 2000) as well as in other books, literature, product formularies, etc. familiar to those skilled in the art. A few representative example formulations are described here as illustrations. For example, a rinse aid for use in household automatic dishwashing or in industrial and institutional warewashing may have the ingredients described below.

Typical Rinse Aid Formulation

| | |
|---|---|
| Compound(s) of Formula (I) or (II) | 0.001 to 45 wt % |
| Nonionic surfactant other than a compound | 0 to 45 wt % |
| of Formula (I) or (II) (e.g. alkoxylated | |
| alcohol(s), alkoxylated block copolymers, etc.) | |
| Hydrotrope (e.g. sodium xylenesulfonate, | 0 to 10 wt % |
| sodium toluenesulfonate, anionic surfactant(s), | |
| amphoteric surfactant(s), etc.) | |
| Isopropyl alcohol or ethyl alcohol | 0 to 10 wt % |
| Chelant (e.g. citric acid, etc.) | 5 to 20 wt % |
| Water, and optionally other ingredients | Balance to 100 wt % |

Typical Powdered Laundry Detergent Formulation

| | Amount by | Amount by |
|---|---|---|
| | Weight in | Weight in |
| | Conventional | Concentrated |
| Material | Formulation | Formulation |
| Compound(s) of Formula (I) or | 0.001 to 5 wt % | 0.001 to 15 wt % |
| (II) | | |
| Detergent surfactant(s) (e.g. | 0.1 to 30 wt % | 0.1 to 50 wt % |
| anionic surfactants, alcohol | | |
| alkoxylates, etc.) | | |
| Builder/co-builder (zeolites, | 25 to 50 wt % | 25 to 60 wt % |
| sodium carbonate, phosphates, | | |
| etc.) | | |
| Bleach and bleach activator | 0 to 25 wt % | 0 to 25 wt % |
| (perborates, etc.) | | |
| Other Additives (fragrance, | 0 to 7 wt % | 1 to 10 wt % |
| enzymes, hydrotropes, etc.) | | |
| Fillers (sodium sulfate, etc.) | 5 to 35 wt % | 0 to 12 wt % |

Typical Aqueous Liquid Laundry Detergent Formulation

| | Amount by | Amount by |
|---|---|---|
| | Weight in | Weight in |
| | Conventional | Concentrated |
| Material | Formulation | Formulation |
| Compound(s) of Formula (I) | 0.001 to 25 wt % | 0.001 to 30 wt % |
| or (II) | | |
| Detergent surfactant(s) | 0 to 35 wt % | 0 to 65 wt % |
| (e.g. anionic surfactants, | | |
| alcohol alkoxylates, etc.) | | |
| Builder/co-builder (citrate, | 3 to 30 wt % | 0 to 36 wt % |
| tartrate, etc.) | | |
| Other Additives (fragrances, | 0.1 to 5 wt % | 1 to 5 wt % |
| dyes, etc.) | | |
| Water and other solvents | 5 to 75 wt % | 1 to 56 wt % |
| (e.g. lower alcohols) | | |

Typical Non-Aqueous Laundry Detergent Formulation

| Material | Amount by Weight |
|---|---|
| Compound(s) of Formula (I) or (II) | 0.001 to 30 wt % |
| Detergent surfactant(s) (e.g. anionic | 0.1 to 42 wt % |
| surfactants, alcohol alkoxylates, | |
| amine oxides, etc.) | |
| Builder/co-builder (zeolites, sodium | 25 to 60 wt % |
| carbonate, phosphates, citrate or | |
| tartrate salts, etc.) | |
| Bleach and bleach activator (perborates, etc.) | 0 to 20 wt % |
| Anti-redeposition aids (sodium | 0.5 to 5 wt % |
| carboxymethylcellulose, etc.) | |
| Other Additives (fragrance, enzymes, etc.) | 0 to 5 wt % |
| Polyalkylene glycol | 0 to 50 wt % |

Typical 2-Part Industrial and Institutional Laundry Formulation

Amount by Weight of
Material in Each
Pack

Pack A

| | |
|---|---|
| Compound(s) of Formula (I) or (II) | 0.001 to 20 wt % |
| Detergent surfactant(s) (e.g. anionic | 0 to 20 wt % |
| surfactants, alcohol alkoxylates, etc.) | |
| Antiredeposition aids (sodium | 0.01 to 2 wt % |
| carboxymethylcellulose, etc.) | |
| Water, and optionally other ingredients | Balance to 100 wt % |

Pack B

| | |
|---|---|
| Sodium silicate | 5 to 10 wt % |
| Sodium metasilicate | 0 to 30 wt % |
| Tetrapotassium pyrophosphate | 0 to 10 wt % |
| potassium hydroxide | 0 to 35 wt % |
| potassium carbonate | 0 to 15 wt % |
| Water, and optionally other ingredients | Balance to 100 wt % |
| Mix Ratio Pack A:Pack B | 1:2 to 1:4 |

Typical Shampoo or Liquid Body Wash Formulation

| Material | Amount by Weight |
|---|---|
| Compound(s) of Formula (I) or (II) | 0.001 to 5 wt % |
| Anionic surfactant(s) (e.g. sodium or | 0.1 to 30 wt % |
| ammonium lauryl sulfate, sodium or | |
| ammonium lauryl sulfate, etc.) | |
| Amphoteric cosurfactant(s) (e.g. | 0 to 20 wt % |
| cocoamidopropyl betaine, etc.) | |
| Nonionic surfactant other than a compound | 0 to 20 wt % |
| of Formula (I) or (II) (e.g. alcohol | |
| alkoxylates, sorbitan esters, alkyl | |
| glucosides, etc.) | |
| Cationic polymers (e.g. polyquaternium, etc.) | 0 to 5 wt % |
| Other Additives (fragrance, dyes, oils, | 0 to 15 wt % |
| opacifiers, preservatives, chelants, | |
| hydrotropes, etc.) | |
| Polymeric thickeners (e.g. polyacrylate, etc.) | 0 to 2 wt % |
| Conditioning oils (e.g. sunflower oil, | 0 to 10 wt % |
| petrolatum, etc.) | |
| Citric acid | 0 to 2 wt % |
| Ammonium chloride or sodium chloride | 0 to 3 wt % |
| Humectants (e.g. propylene glycol, | 0 to 15 wt % |
| glycerin, etc.) | |
| Glycol distearate | 0 to 5 wt % |
| Cocoamide (i.e. cocoamide MEA, | 0 to 10 wt % |
| cocoamide MIPA, PEG-5 cocoamide, etc.) | |
| Dimethicone | 0 to 5 wt % |
| Behenyl alcohol | 0 to 5 wt % |
| Water, and optionally other ingredients | Balance to 100 wt % |

Typical Hair Conditioner Formulation

| Material | Amount by Weight |
|---|---|
| Compound(s) of Formula (I) or (II) | 0.001 to 10 wt % |
| Nonionic surfactant other than a compound | 0.1 to 10 wt % |
| of Formula (I) or (II), and/or fatty | |
| alcohol(s) (e.g. stearyl alcohol, etc.) | |
| Cationic surfactant(s) (e.g. cetrimonium | 0 to 10 wt % |
| chloride, etc.) | |
| Anionic surfactants (e.g. TEA- | 0 to 5 wt % |
| dodecylbenzenesulfonate, etc.) | |
| Silicones (e.g. dimethicone, dimethiconal, etc.) | 0 to 5 wt % |
| Cationic polymers (e.g. polyquaternium, etc.) | 0 to 10 wt % |
| Other Additives (fragrance, dyes, oils, | 0 to 10 wt % |
| opacifiers, preservatives, chelants, | |
| hydrotropes, etc.) | |
| Thickening polymers (e.g. | 0 to 5 wt % |
| hydroxyethylcellulose, polyacrylates, etc.) | |
| Potassium, ammonium or sodium chloride | 0 to 5 wt % |
| Humectant (e.g. propylene glycol, etc.) | 0 to 5 wt % |
| Panthenol | 0 to 2 wt % |
| Water, and optionally other ingredients | Balance to 100 wt % |

Typical Aqueous Sunscreen Formulation

| Material | Amount by Weight |
|---|---|
| Compound(s) of Formula (I) or (II) | 0.001 to 30 wt % |
| Polyethylene glycol (e.g. PEG-8, etc.) | 0 to 30 wt % |
| Active sunscreen agents (e.g. octyl | 1 to 30 wt % |
| methoxycinnamate, azobenzone, homosalate, | |
| octyl salicylate, oxybenzone, octocrylene, | |
| butyl methoxydibenzoylmethane, octyl | |
| triazone, etc.) | |
| Esters and emollients (e.g. dimethicone, | 0 to 20 wt % |
| methylparaben, propylparaben, polysorbates, | |
| etc.) | |
| Thickening polymers (e.g. acrylates/C10-30 | 0 to 20 wt % |
| alkyl acrylate crosspolymer, PVP/hexadecene | |
| copolymer, etc.) | |
| Other Additives (fragrance, dyes, oils, | 0 to 15 wt % |
| opacifiers, preservatives, chelants, etc.) | |
| Solvent/hydrotropes (e.g. propylene glycol, | 0 to 20 wt % |
| benzyl alcohol, dicapryl ether, etc.) | |
| Triethanolamine | 0 to 5 wt % |
| Water, and optionally other ingredients | Balance to 100 wt % |

### Cement Admixture Formulations

Cement admixtures may be of any of several types, including superplasticizing, plasticizing, accelerating, set retarding, air entraining, water-resisting, corrosion inhibiting, and other types. Such admixtures are used to control the workability, settling and end properties (strength, impermeability, durability and frost/deicing salt resistance, etc.) of cementitious products like concretes, mortars, etc. The admixtures are usually provided as aqueous solutions and they can be added to the cementitious system at some point during its formulation. Surfactants of this invention may provide wetting, foam control, flow and leveling, water reduction, corrosion inhibition, high ionic strength tolerance and compatibility, and other benefits when used in such systems.

Exemplary Cement Admixture Ingredients

| | Amount by Weight |
|---|---|
| | Relative to Cement |
| Material | Weight |
| Compound(s) of Formula (I) or (II) | 0.001 to 5 wt % |
| Solubilizing agents (solvent, hydrotropes, | 0 to 10 wt % |
| amines, etc.) * | |
| Polymers and/or oligomers (e.g. lignosulfonates, | 0 to 5 wt % |
| sulfonated melamine formaldehyde condensates, | |
| polycarboxylates, styrene-maleic anhydride | |
| oligomers, copolymers and their derivatives, | |
| etc.) * | |
| Functional Additives (defoamers, air entraining | 0 to 5 wt % |
| or detraining agents, pH control additives, | |
| corrosion inhibitors, set retarders, | |
| accelerators, preservatives, etc.) * | |
| Water | 40 to 75% |

* To total, in combination, between 0.1 and 20 wt %.

### Oil and Gas Field Formulations

Surfactants of this invention, used alone or as a component in formulations, may provide surface tension reduction, foam control, and improved wetting in a variety of applications within the Oil and Gas industry. These may include, for example, formulations for the following uses.

In drilling applications, the surfactants may be used in formulations for dispersion of clays and drill cuttings, ROP (rate of penetration) enhancement, emulsification and de-emulsification, surface wetting and surface tension reduction, shale stabilization, and enhancement of hydration or dissolution of solid additives.

In cementing, stimulation and workover applications, uses may include formulations for spacers, cement dispersion, de-air entraining and defoaming, cement retardation, fracturing fluids, stimulation of coal bed methane, surface or interfacial tension reduction, oil/water wetting, and cleaning fluids.

In oil and gas production, uses may include rig wash formulations, defoaming of crude, water flooding/injection, defoaming for acid gas sweetening, oil/water separation, enhanced oil recovery, and inhibition or dispersion of asphaltenes, hydrates, scale and waxes.

Exemplary fluids for drilling, completing, cementing, stimulating, fracturing, acidizing, or working over, or other treating of subterranean wells, or for enhancing production from an oil- or gas-bearing formation or treating the produced oil or gas, typically include from 0.05 to 10 wt % of a surfactant of this invention in a fluid containing water and/or an organic liquid, which typically constitutes from 5 to 99.85 wt % of the fluid. The organic liquid is typically a petroleum product, although it need not be, and may for example include crude oil or any of the drilling mud base oils described below. If water is included, it may be from a freshwater, sea water, or brine source, or it may be provided by inclusion of an aqueous mineral acid such as hydrochloric acid, hydrofluoric acid, sulfuric acid, etc. Fluids for such applications usually also include between 0.1 and 80 wt % in total of one or more ingredients selected from weighting agents, viscosifiers, dispersants, drilling mud base oils, emulsifiers, soluble salts, cements, proppants, mineral acids, organic acids, biocides, defoamers, demulsifiers, corrosion inhibitors, friction reducers, gas hydrate inhibitors, hydrogen sulfide removal or control additives, asphaltene control additives, paraffin control additives, and scale control additives. A variety of specific materials are known in the art for performing these functions. Suitable nonlimiting examples of some of these materials follow, and others will be apparent to those of skill in the art.

Weighting agents: barium sulfate, hematite, and ilmenite.

Viscosifiers: clays (e.g. bentonite, attapulgite), water-soluble polymers (e.g. xanthan gum, guar, polysaccharides, modified polysaccharides), organophilic clays, and oil-soluble polymers.

Dispersants: lignosulfonates, naphthalene sulfonates, sulfonated melamine formaldehyde resins.

Drilling mud base oils: diesel, mineral oil, olefinic oils, paraffinic oils, and esters.

Emulsifiers: fatty acids, fatty amides, anionic surfactants, and nonionic alkoxylated surfactants.

Soluble salts (e.g. for specific gravity adjustment, shale stabilization, or osmotic pressure control): NaCl, NaBr, KCl, KBr, CaCl₂, CaBr₂, ZnCl₂, ZnBr₂, sodium formate, potassium formate, and cesium formate.

Cements

Other Surfactants: cationic surfactants, amphoteric surfactants, alkyl glucosides, phosphate esters, and fluorosurfactants.

Proppants: ceramics, sintered bauxite, sand, and resin-coated sand.

Organic Acids: formic acid, acetic acid, citric acid.

Mineral acids: hydrochloric acid and hydrofluoric acid.

The foregoing classes of materials may find application, when used in combination with the surfactants of this invention, in a variety of oilfield applications. Depending upon the exact application and desired effect, compositions may be injected into a well or added to the stream of oil or gas produced by the well, all according to methods well known in the art.

Typical applications, and the ingredients commonly (although not necessarily) used in making formulations for these purposes, are shown immediately below. Other ingredients may also be present. It will be understood that each of these formulations will also contain a surfactant according to the invention.

Water-based drilling muds: weighting agents, viscosifiers, and dispersants.

Oil-based drilling muds: base oil, emulsifier, and viscosifier.

Completion fluids: soluble salts for specific gravity adjustment.

Cement Formulations: the cements themselves, in combination with dispersants.

Spacers: weighting agents and surfactants.

Acidizing fluids: surfactants and one or both of mineral acids and organic acids.

Fracturing fluids: viscosifiers, proppants, and surfactants.

Fluids for stimulating or enhancing production from a gas or oil bearing formation, may contain ingredients similar to those found in fracturing fluids, except for proppants. Finally, fluids for treating oil or gas produced in the above ways may include one or more of biocides, defoamers, demulsifiers, corrosion inhibitors, friction reducers, gas hydrate inhibitors, hydrogen sulfide removal or control additives, asphaltene control additives, paraffin control additives, and scale control additives.

Compounds according to formula (I) or (II) may have utility in preventing or slowing the formation of gas hydrates in petroleum-bearing formations or during transport of crude petroleums, where lower hydrocarbons such as methane, ethane, propane, n-butane, and iso-butane are commonly found. Water is also typically present in such formations and, under conditions of elevated pressure and reduced temperature, mixtures of the water and lower hydrocarbons tend to form clathrate hydrates. Such hydrates are water crystals that have formed a cage structure around a guest molecule such as the lower hydrocarbon. For example, at a pressure of about 1 MPa, ethane can form gas hydrates with water at temperatures below 4° C.; at a pressure of 3 MPa, it can form gas hydrates with water at temperatures below 14° C. Temperatures and pressures such as these are commonly encountered in many environments in which natural gas and crude petroleum are produced and transported. The resulting hydrates frequently cause pipeline blockages due to growth and agglomeration of crystals inside pipes, conduits, valves, and other equipment, resulting in reduced flow and even equipment damage.

Compounds according to formula (I) or (II) may be used to reduce the nucleation, growth, and/or agglomeration of gas hydrates by including them in petroleum streams, thereby minimizing unscheduled shutdowns, maintenance and repair. The amount of compound of formula (I) or (II) used for such an application may vary over a wide range, and may depend inter alia upon the relative proportions of the various lower hydrocarbons present in the crude petroleum, the temperature and pressure conditions to which the petroleum will be exposed, and the amount of water present. An appropriate amount for any given situation can easily be determined by routine experimentation, but typically the amount will be at least about 0.05 wt % relative to the amount of water present, more typically at least about 0.1 wt %, and most typically at least about 0.3 wt %. While there need be no upper limit to the amount of compound of formula (I) or (II) used, it may be most economical to limit it to at most about 5 wt % relative to water and typically at most 2 wt % relative to water

As will be appreciated in light of the foregoing discussion, the compounds of this invention may find utility in a wide variety of applications. The present invention is further illustrated by the following examples, which are presented for purposes of demonstrating, but not limiting, the methods and compositions of this invention.

### EXAMPLES

### Example 1

### 1,2-Decanediol Vanillin Acetal

A 50.5 g portion of vanillin and 65 g of 1,2-decanediol were combined in a 250 mL round bottom flask equipped with a Dean Stark apparatus, along with 1.2 g of 85% phosphoric acid and 125 mL hexanes. The reaction mixture was refluxed until one equivalent of water was removed in the Dean Stark receiver arm. The mixture was neutralized by stirring over potassium bicarbonate and filtered through a plug of basic alumina. Vacuum distillation of the reaction mixture yielded 91.2 g of product, 89.4% yield. Distilled product purity by GC (gas chromatography) was 99.5%.

### Example 2

### 1,2-Octanediol Vanillin Acetal

A 50 g portion of vanillin and 51 g of 1,2-octanediol were combined in a 250 mL round bottom flask equipped with a Dean Stark apparatus, along with 1.5 g of 85% phosphoric acid and 125 mL hexanes. The reaction mixture was refluxed until one equivalent of water was removed in the Dean Stark receiver arm. The mixture was neutralized by stirring over potassium bicarbonate and filtered through a plug of basic alumina. Vacuum distillation of the reaction mixture yielded 73.8 g of product, 80% yield. Distilled product purity by GC was 94.6%.

### Example 3

### 1,3-Butanediol Vanillin Acetal

A 10.15 g portion of vanillin and 7.0 g of 1,3-butanediol were combined in a 100 mL round bottom flask equipped with a Dean Stark apparatus, along with 0.33 g of 85% phosphoric acid and 31 g hexanes. The reaction mixture was refluxed until one equivalent of water was removed in the Dean Stark receiver arm. The mixture was neutralized by stirring over potassium bicarbonate and filtered through a plug of basic alumina. Vacuum distillation of the reaction mixture yielded the acetal at a purity by GC of 94.6%.

### Example 4

### Glyceryl 2-ethylhexyl Ether Vanillin Acetal

A 20 g portion of vanillin and 32 g of glyceryl 2-ethylhexyl ether were combined in a 100 mL round bottom flask equipped with a Dean Stark apparatus, along with 0.57 g of 85% phosphoric acid and 50 mL hexanes. The reaction mixture was refluxed until one equivalent of water was removed in the Dean Stark receiver arm. The mixture was neutralized by stirring over potassium bicarbonate and filtered through a plug of basic alumina. Vacuum distillation of the reaction mixture yielded 39.5 g of product, at a purity by GC of 97.5%.

### Example 5

### 1,2-Decanediol Vanillin Acetal Ethoxylation

A 176.6-g portion of 1,2-decanediol vanillin acetal and 3.6 g of 45% aqueous NaOH were combined, and vigorously stirred for 5 hours at 100° C. The mixture was then placed under a reduced pressure of 50 mtorr at 100° C. overnight to remove water. Ethoxylation was subsequently carried out in a 1-liter stainless steel oil jacketed Parr reactor with a sample dip tube, internal thermocouple, subsurface feed and twin pitch blade turbine agitator. Three samples of ethoxylated 1,2-decanediol vanillin acetals were produced in order of increasing ethoxylation (5, 9, and 12 moles ethylene oxide). The samples were produced in one continuous ethoxylation step from the same starting material, according to the following procedure.

The 5 mole ethoxylate was produced by charging 172.42 g of acetal, dried to 0.0% residual water as measured by Karl Fischer titration. The reactor was closed, purged, and pressure tested with nitrogen to 300 psig. After pressure testing, the reactor was vented and repressurized to 102 psig with nitrogen. The reactor was then heated to 120° C., after which 123.22 g of ethylene oxide was fed subsurface at 5 mL/min via a high pressure syringe pump (ISCO model 500D). The reactor temperature reached a maximum of 123° C. during the initial minutes of ethylene oxide feed. The reactor pressure gradually rose to a maximum 256 psig. Although the ethylene oxide was continually being fed to the reactor at 5 mL/min, the pressure began to decrease at this point. The pressure dropped to 228 psig by the end of the ethylene oxide addition and was at 182 psig only 3 minutes after the addition was complete. The reactor contents were held at 1200 for an additional 5 hours, reaching a final pressure of 118 psig, before taking out a sample (41.75 g, designated 5EO).

The 9 mole ethoxylate was produced immediately after taking the 5EO sample. An 80.23 g portion of ethylene oxide was fed to the reactor at 5 mL/min. The temperature was maintained at 120° C. while the pressure rose gradually to 155 psig at the end of the ethylene oxide addition. The reactor contents were held at 120° C. for 8 hours, at which time the reactor automatically shut down. The next day the reactor was heated to 120° C. while the pressure was 119 psig. A sample (31.05 g, designated 9EO) was taken at this point.

The 12 mole ethoxylate was immediately produced after taking the 9EO sample. With the reactor at 120° C. and 113 psig, 53.54 g ethylene oxide was fed to the reactor at 5 mL/min. The temperature was maintained at 120° C. while the pressure rose gradually to 158 psig at the end of the ethylene oxide feed and decreased to 121 psig after 1.5 hours. The reactor contents were held at 120° C. for a total of 8 hours before taking out the sample (291.9 g, designated 12EO).

### Example 6

### 1,2-Octanediol Vanillin Acetal Ethoxylation

A 146.8 g portion of 1,2-octanediol vanillin acetal and 3.3 g of 45% aqueous NaOH were combined, and vigorously stirred for 5 hours at 100° C. The mixture was then placed under a reduced pressure of 50 mtorr at 100° C. overnight to remove water. Ethoxylation was subsequently carried out in a 1-liter stainless steel oil jacketed Parr reactor with a sample dip tube, internal thermocouple, subsurface feed and twin pitch blade turbine agitator. Three samples of ethoxylated 1,2-octanediol vanillin acetals were produced in order of increasing ethoxylation (5, 9, and 12 moles ethylene oxide). The samples were produced in one continuous ethoxylation step from the same starting material, according to the following procedure.

The 5 mole ethoxylate was produced by charging 143.2 g of acetal, dried to 0.0% residual water as measured by Karl Fischer titration. The reactor was closed, purged, and pressure tested with nitrogen to 300 psig. After pressure testing, the reactor was vented and repressurized to 100 psig with nitrogen. The reactor was then heated to 120° C., after which 112.5 g of ethylene oxide was fed subsurface at 5 mL/min via a high pressure syringe pump (ISCO model 500D). The reactor contents were held at 120° for an additional 5 hours, reaching a final pressure of 120 psig, before taking out a sample (44.9 g, designated 5EO).

The 9 mole ethoxylate was produced immediately after taking the 5EO sample. A 74.2 g portion of ethylene oxide was fed to the reactor at 5 mL/min. The temperature was maintained at 120° C. The reactor contents were held at 120° C. for 8 hours, at which time the reactor automatically shut down. The next day the reactor was heated to 120° C. while the pressure was 120 psig. A sample (47.7 g, designated 9EO) was taken at this point.

The 12 mole ethoxylate was immediately produced after taking the 9EO sample. With the reactor at 120° C. and 115 psig, 46.3 g ethylene oxide was fed to the reactor at 5 mL/min. The temperature was maintained at 120° C. for a total of 8 hours before taking out the product (designated 12EO).

Surfactant Performance Evaluation

Equilibrium surface tensions were determined for the compounds prepared in Examples 5 and 6, using a Kruss K-12 tensiometer with a platinum Wilhelmy plate, maintaining the temperature at 25±1° C. by means of a constant temperature circulating bath. The results, reported in Table 1, are averages of 10 measurements over a 10-minute period, and have a standard deviation of less than 0.01 dyne/cm. Foam height and foam stability (foam height as a function of time) were measured by a slightly modified Ross-Miles foam test (Am. Soc. For Testing Materials, Method D1173-53, Philadelphia, Pa., 1953), using 0.1 wt % aqueous solutions of the surfactants. These results are also presented in Table 1.

TABLE 1

| | | | Foam | Foam | Foam | Foam | Foam | Foam |
|---|---|---|---|---|---|---|---|---|
| Example | EST 0.1% | EST 1.0% | 0 sec | 30 sec | 1 min | 2 min | 5 min | 10 min |
| 6, 5EO | 31.4 | 31.74 | 12.5 cm | 12.5 cm | 12.5 cm | 12.0 cm | 11.0 cm | 10.0 cm |
| 6, 9EO | 33.2 | 35.1 | 11.6 cm | 11.6 cm | 11.6 cm | 11.0 cm | 11.0 cm | 8.0 cm |
| 6, 12EO | 34.47 | 36.96 | 10.5 cm | 10.2 cm | 10.2 cm | 10.0 cm | 9.7 cm | 9.3 cm |
| 5, 5EO | insoluble | insoluble | insoluble | insoluble | insoluble | insoluble | insoluble | insoluble |
| 5, 9EO | 35.25 | 35.03 | 11.7 cm | 11.7 cm | 11.5 cm | 11.5 cm | 11.0 cm | 11.0 cm |
| 5, 12EO | 38.37 | 38.01 | 10.0 cm | 9.7 cm | 9.5 cm | 9.5 cm | 8.5 cm | 7.0 cm |

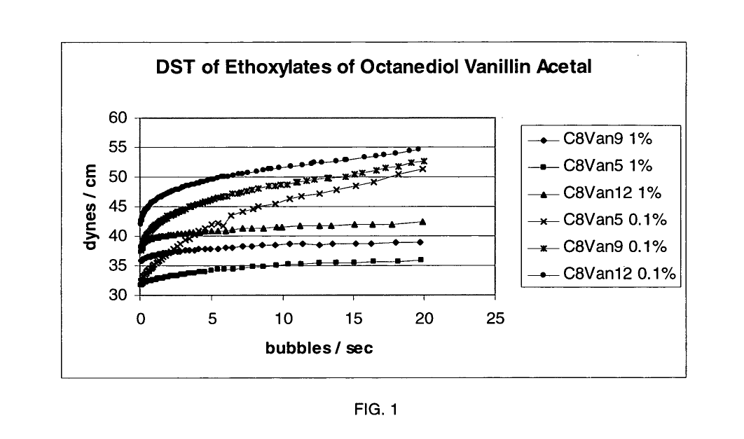

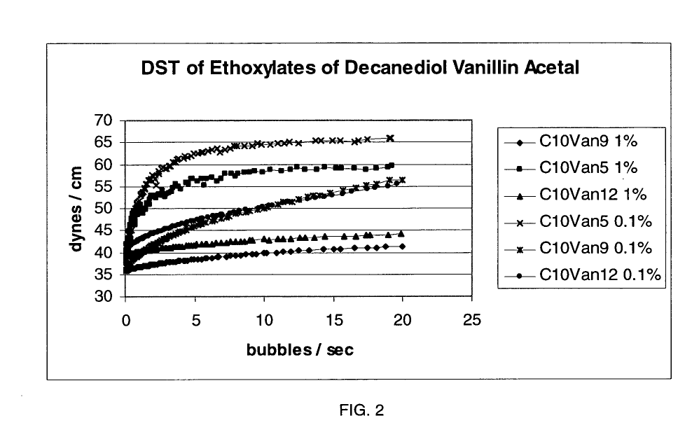

Dynamic surface tensions were determined using a Kruss BP-2 Bubble Pressure Tensiometer by the maximum bubble pressure method, as described in Langmuir 1986, 2, 428-432. The results of these determinations are shown in FIGS. 1 and 2, where the label C8Van9 represents Example 6 (the octanediol-vanillin based product) sample 9EO, and the label C10Van5 represents Example 5 (the decanediol-vanillin based product) sample 5EO, etc.

The data in Table 1 and FIGS. 1 and 2 demonstrate that the compounds of this invention effectively reduce equilibrium surface tension, as well as dynamic surface tension, of aqueous solutions and serve to affect the foam properties of aqueous solutions. The demonstrated low equilibrium surface tension values may enhance the ability of formulations containing these compounds to wet out a given surface. The demonstrated low dynamic surface tension values provide information about the performance of a surfactant at conditions ranging from close to equilibrium (0.1 bubbles/sec) through high surface creation rates or dynamic conditions (10-20 bubbles/sec). In a practical sense, high surface creation rates are relevant to rapid processes such as spray or roller-applied coating, high speed printing operations, or the rapid application of an agricultural product or a cleaner. While applications such as coatings, inks, and adhesives require low foam or foam that dissipates quickly, other applications such as cleaning or floatation require a controlled amount of foam to be present and to persist.

Surfactant Biodegradability Evaluation

Biodegradability of two surfactants of this invention, i.e., the 9EO sample from each of Example 5 and Example 6, was compared with that of a positive control (sodium acetate at 100 mg/L). The evaluations were performed using a model #WB 512 pneumatic computerized respirometer, available from N-CON Systems Co., Inc. of Crawford, Ga., run in triplicate according to the following method. No substrate was supplied to the biomass of the endogenous or negative control test cells.

The testing was performed in closed N-CON pneumatic (pure oxygen) respirometer cells for 672 hours (28 days) at biomass VSS (volatile suspended solids) concentrations of 30 mg/L and at a controlled temperature of 25° C. (±2°). These test conditions were consistent with OECD 301C Modified MITI Test (I) for ready biodegradability, except that the sewage seed was taken from a single wastewater treatment plant, instead of a composite from 10 sites as described in the OECD Method 301C.

Activated sludge was collected from aeration-basin activated sludge at the city of Bethlehem, Pa. Wastewater Treatment Plant. The sludge was starved for at least 18 hr before use in the respirometer test. The test cells were inoculated with enough activated sludge for a 3.3 food/mass (F/M) ratio. Biomass, substrate (test sample or control compound), appropriate nutrients (Ca, Mg, Fe, Cl, S, N, and P), and buffers were added to each test cell (500-ml glass bottle with a magnetic stirring bar, and a carbon dioxide trap) to assure favorable growth conditions. All test samples were individually weighed and added directly into the respirometer cells to achieve as close to a targeted concentration of 100 mg/L as possible.

As the oxygen was depleted in the bottles, the resulting cumulative oxygen uptake was calculated and stored on a computer system. From the computer data files, plots were generated of cumulative oxygen uptake activity (in mL O₂) as a function of time (not shown). A set of three surrogate bottles containing only biomass and nutrients were set up and sacrificed to give filtrates for average initial nitrate+nitrite analysis.

After the incubation, chemical oxygen demand (COD) measurements were made on each test cell's unfiltered contents to provide data for biodegradation calculations, in terms of the COD removal as a percent of the carbonaceous theoretical oxygen demand (ThOD) of the compound. The unfiltered final COD values from three negative control cells were averaged to correct for the contribution of final COD from the biomass.

Filtrates were also analyzed for initial and final test concentrations of nitrate-N and nitrite-N by ion chromatography with an anion exchange column and a UV detector. The nitrate-N and nitrite-N values were used to calculate a nitrification correction, to correct the observed oxygen uptake for the oxygen used to oxidize the organic N of the substrate. The net value (observed-nitrification corrected) was the carbonaceous oxygen uptake for the test cell. The average carbonaceous oxygen uptake for the negative controls was then subtracted from the carbonaceous oxygen uptake value from each test cell to correct for the contribution of the biomass.

Calculations for biodegradation were performed as follows:

Carbonaceous oxygen uptake (mg/L O₂), corrected for nitrification and contributions from biomass, measured in a respirometer cell divided by the carbonaceous ThOD and expressed as a percentage.

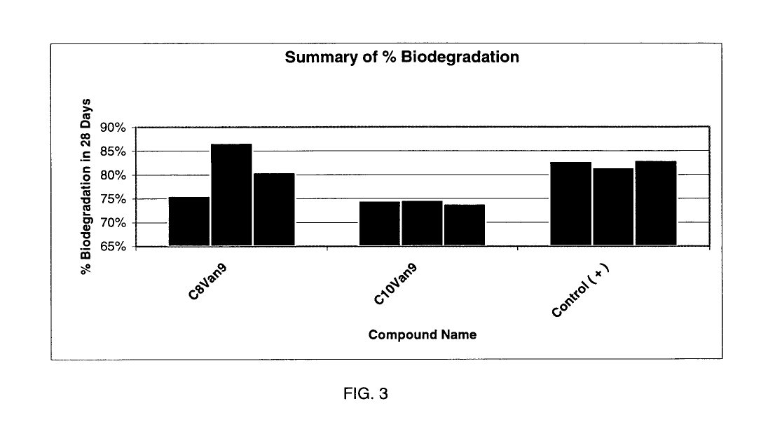

As can be seen in FIG. 3, biodegradation of the two acetal surfactants of this invention was significantly higher than 60%, a level that is typically used to classify a material as Readily Biodegradable, and as good as or nearly as good as that of the positive control.

As described in the foregoing discussions, the invention provides novel surfactants with properties that are suitable for use in a wide range of industrial and commercial applications. Such applications include water-based coatings, inks, adhesives, agricultural formulations, aqueous and non-aqueous cleaning compositions, personal care applications, and formulations for textile processing and oilfield applications.

Although the invention is illustrated and described herein with reference to specific embodiments, it is not intended that the subjoined claims be limited to the details shown. Rather, it is expected that various modifications may be made in these details by those skilled in the art, which modifications may still be within the spirit and scope of the claimed subject matter and it is intended that these claims be construed accordingly.

1. A composition comprising one or more compounds according to formula (I) or formula (II) 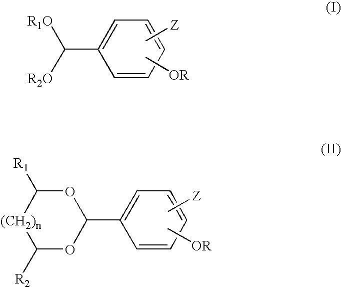
wherein R is (CH₂CH₂O)ₓR₄ or (C₃H₆O₂)ₓR₄; R₁ and R₂ are each independently selected from the group consisting of hydrogen and C1-C20 linear, cyclic, and branched alkyl, alkenyl, aryl, aralkyl, and alkaryl moieties, and wherein if the compound is according to formula (II) wherein n=0, one of R₁ and R₂ may further be C1-C20 alkoxymethylene and the other is H; Z is hydrogen, OR, or OR₃, wherein R₃ is selected from the group consisting of hydrogen, methyl, ethyl and propyl; R₄ is selected from the group consisting of hydrogen, methyl and ethyl; x is an integer from 1 to 20; and n is 0 or 1; provided that neither R₁ nor R₂ may be hydrogen when the compound is of formula (I).

2. The composition of claim 1, wherein the one or more compounds comprises a compound according to formula (I).

3. The composition of claim 2, wherein R is (C₃H₆O₂)ₓR₄.

4. The composition of claim 2, wherein R is (CH₂CH₂O)ₓR₄.

5. The composition of claim 2, wherein OR is at the para position and Z is OR₃ or OR and is at a meta position, relative to the acetal group.

6. The composition of claim 5, wherein R₃ is methyl or ethyl.

7. The composition of claim 6, wherein R is (CH₂CH₂O)ₓR₄ wherein x is at least 3.

8. The composition of claim 1, wherein R₄ is hydrogen.

9. The composition of claim 1, wherein the one or more compounds comprises a compound according to formula (II).

10. The composition of claim 9, wherein R is (C₃H₆O₂)ₓR₄.

11. The composition of claim 9, wherein R is (CH₂CH₂O)ₓR₄.

12. The composition of claim 9, wherein one of R₁ and R₂ is 2-ethylhexyloxymethylene.

13. The composition of claim 9, wherein OR is at the para position and Z is OR₃ or OR and is at a meta position, relative to the acetal group.

14. The composition of claim 13, wherein R₃ is methyl or ethyl.

15. The composition of claim 14, wherein R is (CH₂CH₂O)ₓR₄ wherein x is at least 3.

16. The composition of claim 1, wherein at least one of R₁ and R₂ is C1-C10 linear alkyl.

17. The composition of claim 16, wherein said at least one of R₁ and R₂ is 1-hexyl or 1-octyl.

18. The composition of claim 1, wherein the one or more compounds according to formula (I) or formula (II) constitute a first component, the composition further comprising a second component consisting of one or more materials selected from the group consisting of mineral acids, formic acid, acetic acid, tetramethylammonium hydroxide, nonvolatile organic materials, nonvolatile inorganic materials, and mixtures of these, said second component not including any component of a pre- or post-preparation synthesis reaction mixture for preparation of any of the one or more compounds according to formula (I) or (II), wherein the composition is fluid at 25° C.

19. The composition of claim 18, wherein the second component is present in a greater amount by weight than the first component.

20. The composition of claim 19, the composition further comprising an aqueous carrier.

21. The composition of claim 18, wherein the one or more compounds according to formula (I) or (II) comprises a compound according to formula (I), R₁ is hydrogen, R₂ is n-hexyl, n is 0, Z is hydrogen, R is (CH₂CH₂O)₅H, and OR is at the para position relative to the acetal group.

22. The composition of claim 18, wherein the one or more compounds according to formula (I) or (II) comprises a compound according to formula (I), R₁ is hydrogen, R₂ is n-octyl, n is 0, Z is hydrogen, R is (CH₂CH₂O)₉H, and OR is at the para position relative to the acetal group.

23. A method for reducing surface tension in a formulation, comprising adding to the formulation an effective amount of one or more compounds according to formula (I) or formula (II) sufficient to reduce an equilibrium surface tension of the formulation to a value less than 52 mN/m 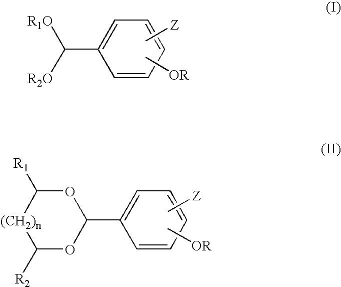
wherein R is (CH₂CH₂O)ₓR₄ or (C₃H₆O₂)ₓR₄; R₁ and R₂ are each independently selected from the group consisting of hydrogen and C1-C20 linear, cyclic, and branched alkyl, alkenyl, aryl, aralkyl, and alkaryl moieties, and wherein if the compound is according to formula (II) wherein n=0, one of R₁ and R₂ may further be C1-C20 alkoxymethylene and the other is H; Z is hydrogen, OR, or OR₃, wherein R₃ is selected from the group consisting of hydrogen, methyl, ethyl and propyl; R₄ is selected from the group consisting of hydrogen, methyl and ethyl; x is an integer from 1 to 20; and n is 0 or 1; provided that neither R₁ nor R₂ may be hydrogen when the compound is of formula (I).

24. In an aqueous composition containing a surfactant for reducing surface tension, the composition selected from the group consisting of coatings, inks, adhesives, agricultural formulations, fountain solutions, photoresist strippers, photoresist developers, shampoos, bodywashes, detergents, and other cleaning compositions, the improvement which comprises using as the surfactant a composition of claim 1.
